(19) United States
(12) Patent Application Publication
(10) Pub. No.: US 2020/0015430 A1
(43) Pub. Date: Jan. 16, 2020

(54) Method and Apparatus for Handling, Cleaning, and Transplanting Growing Towers

(71) Applicant: Eden Works, Inc. (dba Edenworks), Brooklyn, NY (US)

(72) Inventors: Nico HAWLEY-WELD, Brooklyn, NY (US); Dan VOLPE, Brooklyn, NY (US); Ben SILVERMAN, Brooklyn, NY (US)

(21) Appl. No.: 16/577,768

(22) Filed: Sep. 20, 2019

Related U.S. Application Data
(63) Continuation of application No. PCT/US2018/023864, filed on Mar. 22, 2018.
(60) Provisional application No. 62/474,959, filed on Mar. 22, 2017.

(51) Int. Cl. A01G 9/04; A01G 31/04

(52) U.S. Cl. CPC A01G 9/047; A01G 31/045

(57) ABSTRACT

A system includes one or more machines carrying out steps in a plant production process using growing towers, beginning after harvest and concluding immediately after transplanting. These steps include media removal, plant waste disposal, media cleaning, tower cleaning, and tower re-transplanting. A material handling scheme may be used to manage the flow of towers to and from the machine and across the growing system.

### CROSS-REFERENCE TO RELATED APPLICATIONS

This application is a Bypass Continuation Application of International Application No. PCT/US2018/023864, filed on Mar. 22, 2018, which claims the benefit of U.S. Provisional Application No. 62/474,959, filed Mar. 22, 2017.

### FIELD

The present disclosure is in the technical field of controlled environment or indoor agriculture. More specifically, the present disclosure is in the technical field of handling, cleaning, and transplanting into growing towers.

### BACKGROUND

One growing tower popular among small-scale growers includes a solid outer sheath with two open ends, an open slot running the length of its front side, an angled opening on one end of the slot, and a media material inserted into the sheath that serves to structurally support and provide fertigation to individual plants inserted into the slot of the outer sheath. More details about this growing tower can be found in U.S. Pat. No. 8,327,582, the entire disclosure of which is hereby incorporated herein by reference for all purposes.

In current practice, to use such a tower, production follows a series of sequential steps. First, in the transplanting step, the media material is optionally wetted, optionally lined with a wicking strip, and inserted into the tower. For ease of handling, two or more strips of media material can be placed end-to-end within a single tower in order to shorten the length of each media strip required. Once in the tower, the media material is oriented such that it contains a groove aligned with the slotted front face of the tower. This groove allows for the insertion of transplants or seedlings, allows for flexibility in how they are spaced, and serves to clamp the seedlings in place so that the tower can be oriented in any direction without them falling out. The groove in the media is typically achieved by having two strips of media in the tower side-by-side, which in practice is accomplished either by folding single strips of media in half within the tower or using a material consisting of two strips connected at one end with a connecting bolt. The connection at the end allows for the media to be pulled into and out of the tower using a pulling hook. Since this can only be done if the media material resists shear forces and tension, it is ideal for the media material to have considerable shear and tensile strength, in addition to being light, porous, flexible, and having a high surface area.

In the transplanting step, seedlings, usually bound within growing plugs, are placed within the media groove either prior to or simultaneous to inserting the media into the tower. Next, in the growing step, the tower is placed in an area where it has access to water, nutrients, and light, during which the seedlings grow to maturity. The tower can be oriented in any direction, as long as water and nutrients are fed in and out at the ends. If oriented vertically, it is ideal for the tower to be oriented at a slight tilt, so that irrigation water trickles along the back face of the tower instead of trickling to the front and potentially exposing the plant shoots to excess water.

Then, in the harvesting step (which can occur just one time or several times in a cut and come again harvesting scheme), the plant shoots are harvested, leaving the root mass of each plant still intact in the tower. Lastly, in the cleaning step, the media is removed from the tower, the plant root matter and plugs are separated from the media, the media and towers are cleaned, and the production cycle is ready to be repeated again.

Currently, the state of the art is for each of these steps to be performed manually. This is appropriate due to the fact that the average farm using towers such as these is of a small scale and typically has upfront project costs totaling no more than $200 k USD, whereas a typical equipment line for transplanting, harvesting, cleaning, and handling (for other growing systems) can cost several times that much. As such, numerous innovations have emerged making the manual performance of these steps easier, such as rack systems for transport or specialized tables for transplanting. However, due to the very specialized nature of the growing towers considered here, no equipment currently exists to perform the most mechanically difficult steps, including the handling, storage, conveyance, and preparation of materials from one production cycle to the next.

### SUMMARY

Some embodiments of the present disclosure are directed to methods and apparatus for handling, cleaning, and transplanting hydroponic growing towers. These systems, apparatus, and methods can be employed to produce crops, such as leafy greens, herbs, and berries. In one example, a system includes one or more machines carrying out substantially all steps in the production process beginning after harvest and concluding immediately after transplanting. These steps include media removal, plant waste disposal, media cleaning, tower cleaning, and tower re-transplanting. In another example, a material handling scheme is disclosed for the flow of towers to and from the machine and across the growing system.

### BRIEF DESCRIPTIONS OF THE FIGURES

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIGS. 1A-1D show several conventional growing towers.

FIG. 2 illustrates a material handling flow, according to some embodiments.

FIGS. 3A-3C illustrate example configurations of entry of towers into a machine in a direction perpendicular to their longitudinal axis, according to some embodiments. FIG. 3D illustrates an example configuration of entry of towers into a machine in a direction parallel to their longitudinal axis, according to some embodiments.

FIGS. 4A and 4B illustrate example material flows of towers into and out of a machine, according to some embodiments.

FIG. 5 illustrates a schematic of a growing tower with an angled opening and hanging holes on both ends, according to some embodiments.

FIG. 6 illustrates a system including towers housed within a growing system in multiple loops, according to some embodiments.

FIGS. 7A and 7B illustrate paper pot plugs in a chain and an array configuration, respectively, according to some embodiments.

FIG. 8 illustrates a “zipping” method of transplanting, according to some embodiments.

FIG. 9 illustrates a “sandwich” method of transplanting, according to some embodiments.

FIGS. 10A and 10B illustrate an “insertion” method of transplanting, according to some embodiments.

FIG. 11A illustrates a machine where towers are conveyed into the machine with their fronts facing up, according to some embodiments.

FIG. 11B illustrates a machine where towers are conveyed into the machine with their fronts facing sideways, according to some embodiments.

FIGS. 12A-12I illustrate detailed drawings of the machine design shown in FIG. 11A, according to some embodiments.

FIGS. 13 illustrates a machine where towers are conveyed into the machine in a direction parallel the longitudinal axis of the towers, according to some embodiments.

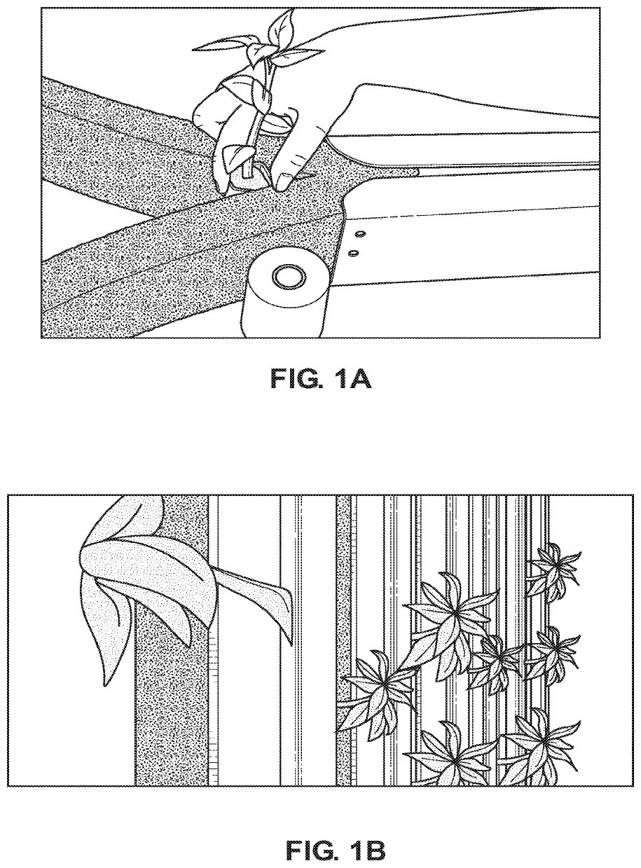

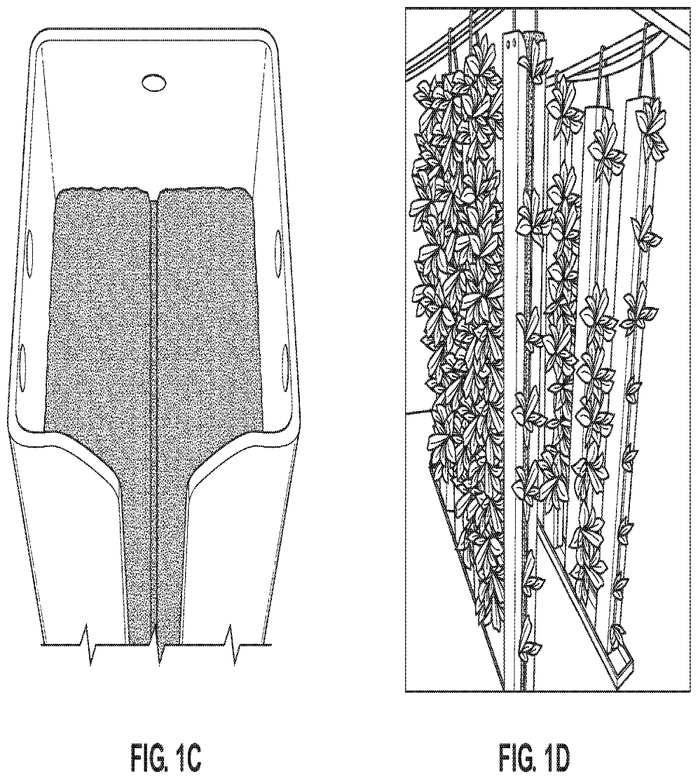

### DETAILED DESCRIPTION

The present disclosure solves the above identified problems and therefore makes the growing towers a viable choice for industrial scale growing facilities, which are typically at least 50 times the size of the smaller scale facilities described above to compete at scale. To accomplish this, the present disclosure provides a machine (or multiple machines) automating all steps in the production process beginning immediately after harvest and concluding immediately after transplanting, as well as a material handling scheme for the flow of towers to and from the machine and across the growing system, and a minor modification to the towers themselves.

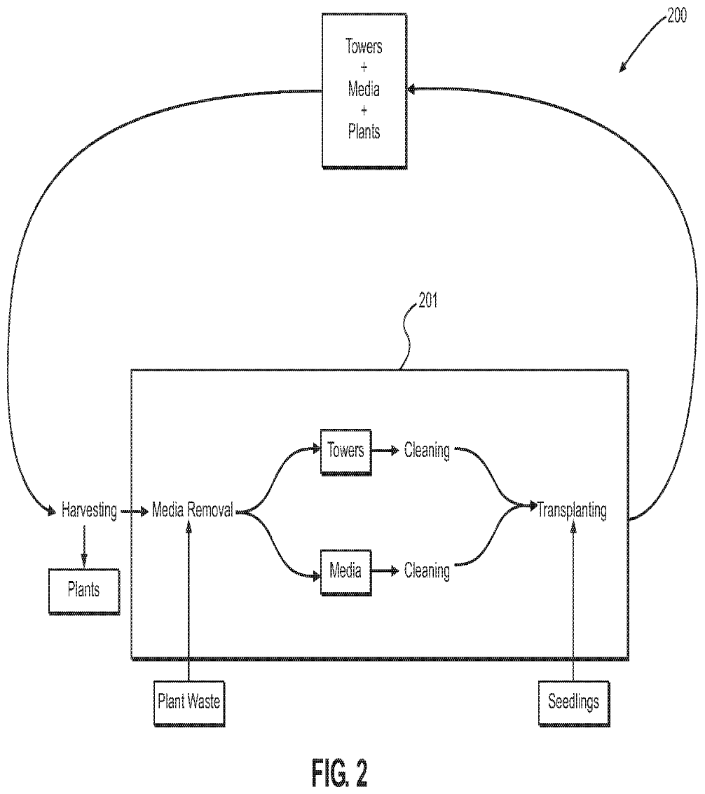

FIG. 2 illustrates a material handling flow 200 for handling, cleaning, and transplanting growing towers, according to some embodiments. The scheme facilitates the automation of all processes within box 201 (either via a single integrated machine or multiple separate machines), as well as a material handling scheme for the flow of towers to and from the machine and across the growing system.

Machine and Facility Material Handling Overview

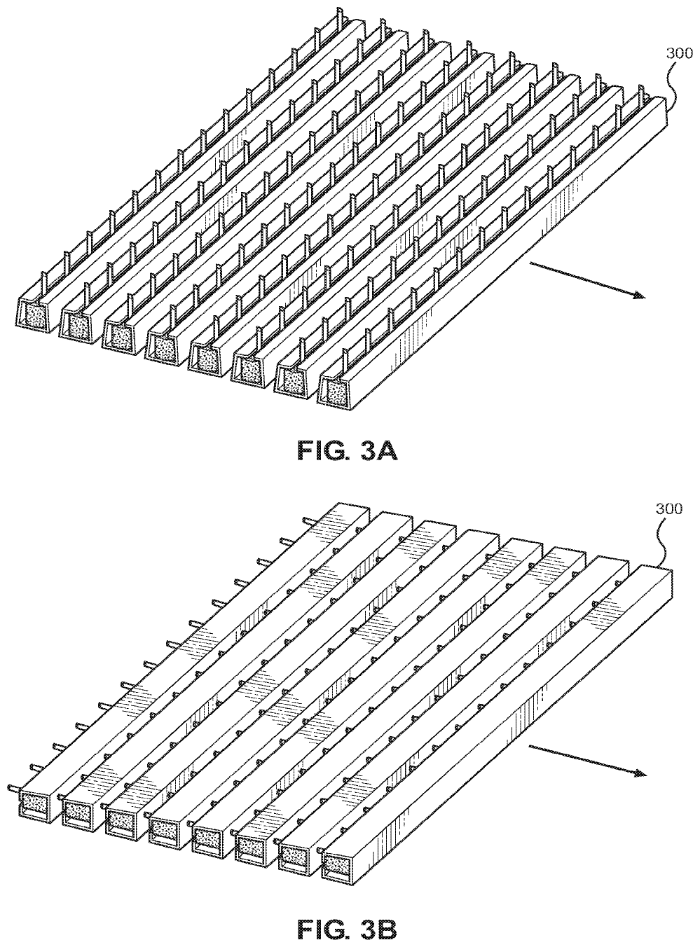

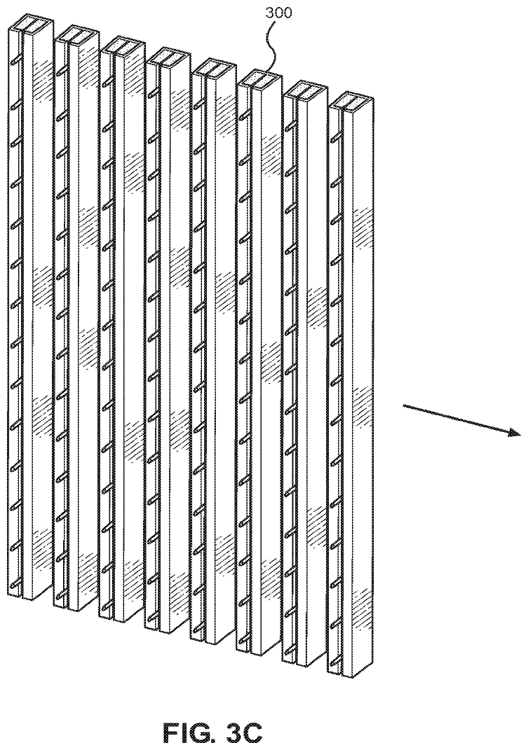

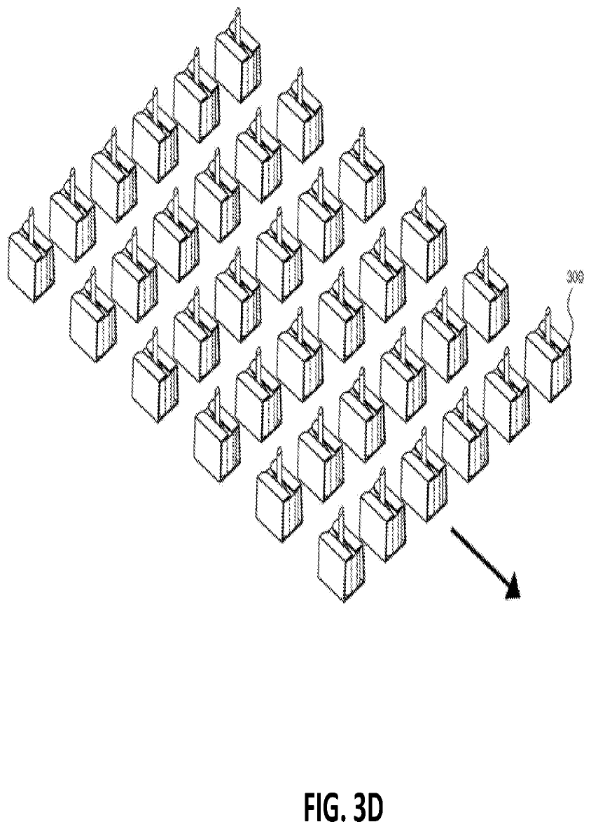

One embodiment of the disclosure can be described as follows. The machine begins with towers at the end of their growth cycle, immediately after they are harvested. Depending on the specifics of the growing system used, the machine can be designed to accept incoming towers in any orientation. For each tower a longitudinal axis can be defined connecting the tower's two open ends. Towers can move either perpendicular or parallel to their longitudinal axis while they are in the machine or being conveyed to and from the machine. In some embodiments, it can be helpful to load the towers into the machine along a direction perpendicular to their longitudinal axis, as shown in FIGS. 3A-3C, although other loading geometries are possible too. FIG. 3A illustrates horizontal entry of towers 300 (along a direction perpendicular to their longitudinal axis), FIG. 3B illustrates sideways entry of towers 300 (along a direction perpendicular to their longitudinal axis), and FIG. 3C illustrates vertical entry of towers 300 (along a direction perpendicular to their longitudinal axis). In some embodiments, it can be helpful to load the towers into the machine along a direction parallel to their longitudinal axis, as shown in FIG. 3D. FIG. 3D illustrates horizontal entry of towers 300 (along a direction parallel to their longitudinal axis). In some embodiments, a tower can move in a direction partially perpendicular to its longitudinal axis while in the machine or being conveyed to or from the machine, which is defined to mean that the tower moves in a direction that has a component which is perpendicular or parallel to the tower's longitudinal axis. In some embodiments, a tower can move in a direction partially parallel to its longitudinal axis while in the machine or being conveyed to or from the machine, which is defined to mean that the tower moves in a direction that has a component which is parallel to the tower's longitudinal axis In one embodiment, the longitudinal length of the towers is between 0.1 times to 10 times the width of the tower.

The machine first separates the media from the towers 300, optionally cleans both, disposes of any plant waste, and then re-transplants new seedlings into the same towers and media already loaded in the machine. To accomplish this, two material flows are can be used. In one example, the media material can be pulled out and re-inserted into the same end of the tower. In another example, the media material can be pulled out and re-inserted into the opposite end where it was pulled from. The choice of flow has implications for the design of the facility. In the latter case, by removing and inserting the media at opposite ends of the towers 300, the growing towers 300 can be conveyed across the growing facility (during the growth phase) without needing to change their orientation for re-entry into the machine at the end of the growing cycle. In the former case, the orientation of the towers 300 can be flipped (e.g., like a Mobius strip) before re-entry into the machine at the end of the growing cycle, so that the orientation of the media and towers 300 remains constant from one growing cycle to the next.

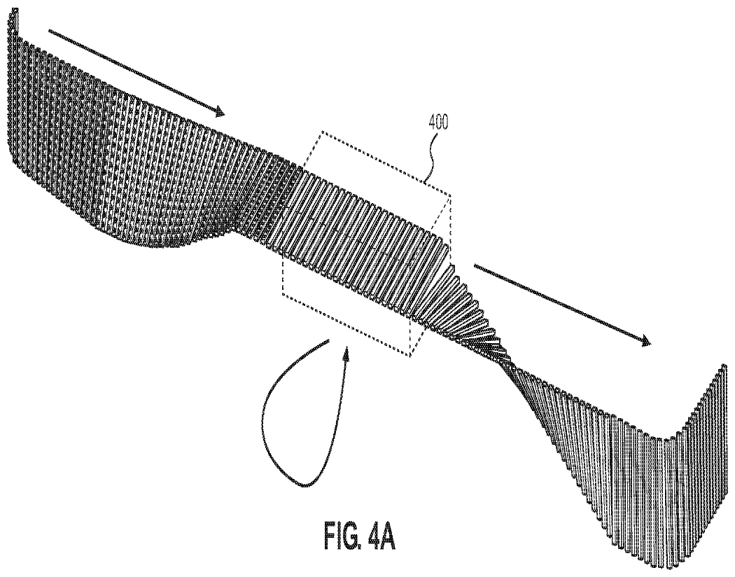

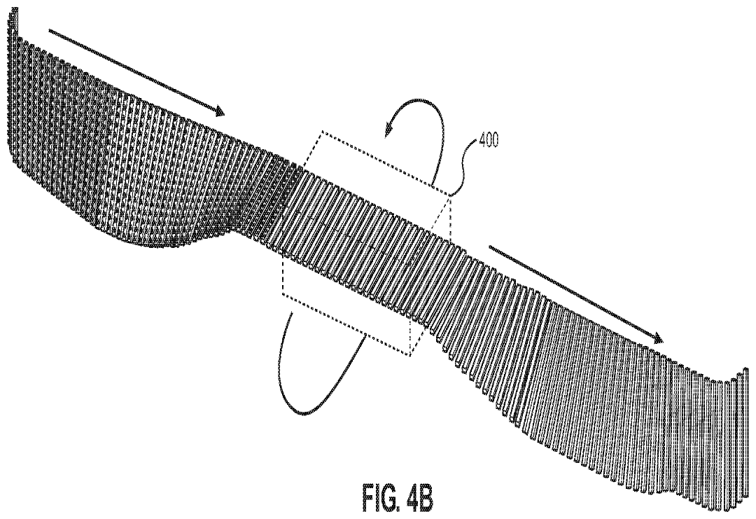

FIGS. 4A and 4B illustrate the material flow of towers into and out of a machine 400. The box represents the machine 400, which performs the media removal, cleaning, and transplanting of seedlings. Towers are brought into the machine 400 using a system of rails (not shown) in which the top rail suspends the tower while the bottom rail acts as a passive guide forcing the towers to switch from a vertical orientation to horizontal and back again. Vertical orientations of towers prior to and after the towers are in the machine can be partially vertical (i.e. oriented with an angle less than 45 degrees to vertical), and horizontal orientations of towers while they are in the machine can be partially horizontal (i.e. oriented with an angle less than 45 degrees to horizontal) FIG. 4A illustrates that the media re-enters the tower on the same side where it was removed from. In this configuration, the towers flip their orientation at some point during the growth cycle. For example, as shown in FIG. 4A, the towers are shown flipping their orientation immediately after exiting the machine. FIG. 4B illustrates that the media re-enters the tower on the on opposite side where it was pulled from. In this configuration, the towers maintain their orientation. Moreover, in an additional embodiment the machine 400 may include a rotating member, such as a manipulator, for rotating the tower 180 degrees so that the opposite end of the tower is placed near the media material that was removed from one end of the tower.

In FIGS. 4A and 4B, the towers are brought into the machine 400 using a system of rails (not shown) in which the top rail suspends the tower while the bottom rail acts as a passive guide forcing the towers to switch from a vertical orientation to horizontal and back again (this can alternatively be achieved by a machine arm too). Even when towers do not re-orient during the production cycle, the aforementioned system of rails or machine arm allows for the towers to be in one orientation while in the growing system (e.g. vertical) and another while in the machine (e.g. horizontal).

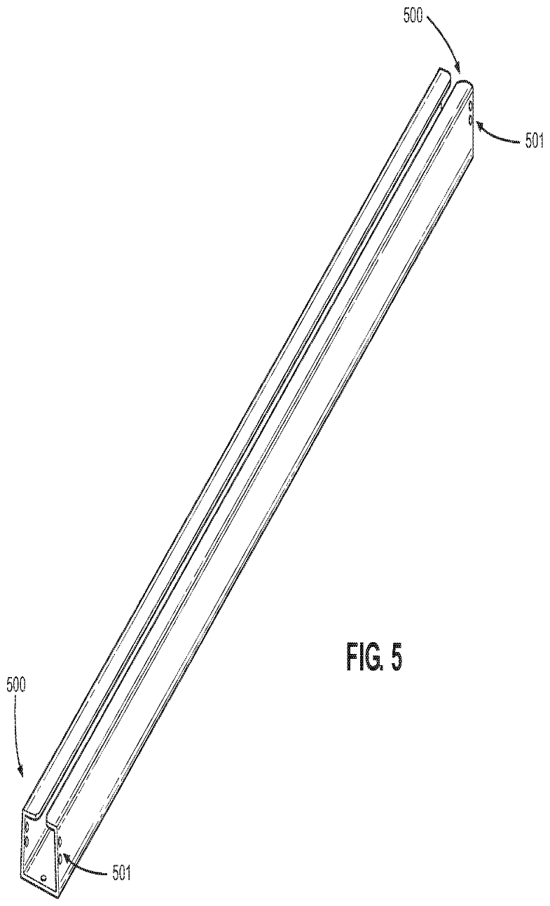

For the towers to be used such that the media is pulled out and re-inserted into the same end of the tower, both ends of the tower can have an angled opening making the transplanting process easier. FIG. 5 illustrates a schematic of a growing tower with an angled opening 500 and hanging holes 501 on both ends. In addition to or instead of hanging holes, the tower can have other means of attachment to a support structure for supporting the tower in a vertical position while the plants in the towers are growing. For the towers to be used such that the media is pulled out and re-inserted into the same end of the tower, both ends of the tower can have an angled opening making the transplanting process easier. In addition, hanging holes or pins can be placed on both ends of the tower so that the tower can be mounted to a support structure with either the first end or the second end of the tower facing upwards. FIG. 5 illustrates a schematic of a growing tower with an angled opening 500 and hanging holes 501 on both ends. In addition to or instead of hanging holes or pins on the tower, the tower can have other means of attachment to a support structure. The support structure can support the tower in a vertical or close to vertical position while the plants in the towers are growing. Such a support structure can hold the towers in place or circulate them through the growing system.

Once the towers leave the machine and are oriented in the correct orientation, they are conveyed into and across the growing system during their growth cycle. One aspect of the present disclosure is for the conveyance system utilized within the machine to be continuous and seamless with the conveyance system utilized to move towers into, across, and out of the growing system. This latter system is useful for industrial scale facilities to compete on cost. In one embodiment, towers in the growing system are housed within a system of carousels acting either as one large loop or several loops in parallel. If several loops in parallel are used, various simple switching mechanisms (e.g., used in train tracks and large dry-cleaning facilities) can be used to route towers between individual loops and the main loop exiting and entering the machine.

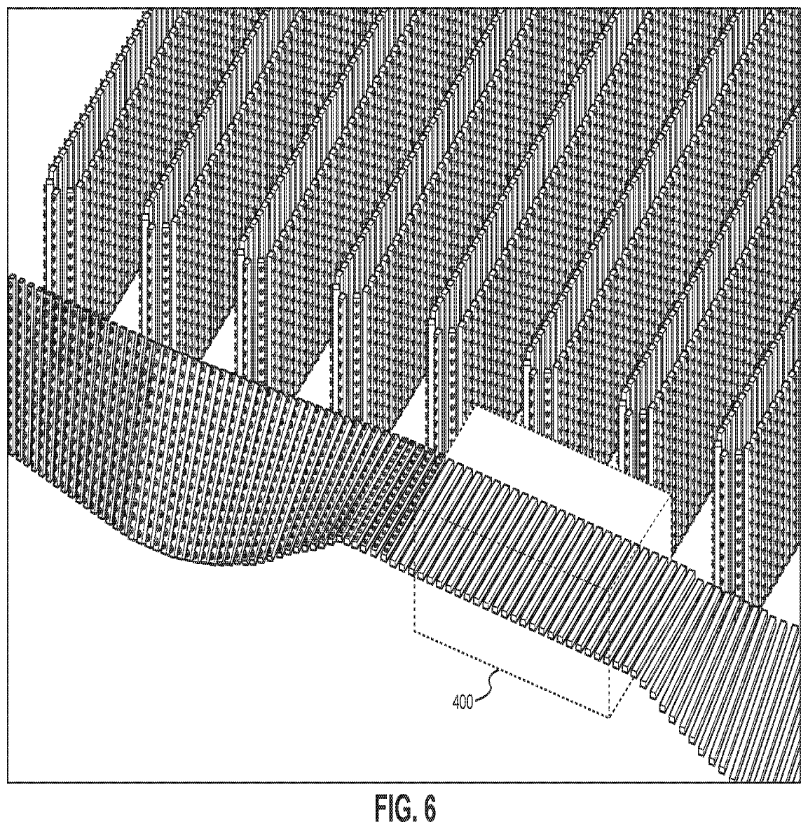

FIG. 6 illustrates a system including towers housed within a growing system in multiple loops. An embodiment of the machine 400 with horizontal tower infeed and outfeed is shown as a box. In one embodiment, such a system can be implemented using multiple vertical tiers, with a harvesting, cleaning, and transplanting line either on each level or on a common level. To accomplish any of this, the towers and their conveyance systems can be mechanically separated from the systems for lighting, irrigation, and high voltage air conditioning (HVAC). This is useful in systems utilizing growing towers and/or when conveyance is automated. This can be achieved by having fixed structures holding the lights and irrigation in place, physically adjacent to a tower conveyance system that is either connected to or separate from the structures for lights and irrigation. The towers can be disposed such that one end is in communication with a nutrient infeed and the other end is in communication with a drain. This can be achieved by having an array of infeed nozzles (with either fixed or variable spacing) under which the towers can be placed, and a shared common drain. If there are multiple vertical tiers of towers, they can be placed such that the upper tiers drain into the lower tiers. Fertigation can be managed such that irrigation is shut off while the towers are being moved; this is one reason why a facility comprised of several tower handling loops can be beneficial.

While the present disclosure does not specifically include an automated harvesting step, it is understood that the towers can be harvested before they enter the machine. While the towers can be harvested in place in the growing system, it can be beneficial to bring the towers to the harvester. The harvester can be placed at any point along the conveyance system prior to entering the cleaning and transplanting machine. In a cut and come again harvesting scheme (multiple harvests before re-transplanting), if the harvester is placed immediately before the cleaning and transplanting machine, then the facility can be designed such that it is possible to re-route the towers back into the growing system without cleaning or re-transplanting them. In one example, a switching mechanism can be implemented such that the towers bypass the cleaning and transplanting machine after the plants are cut. In another example, the machine can incorporate a setting through which towers can be conveyed through it without any processing steps being performed.

While the specification above has described a single integrated machine performing all steps from media removal to re-transplanting, it is entirely within the scope of the present disclosure to separate each of these steps into multiple separate machines, which can be co-located or located in separate areas in a distributed manner. If separate machines are used, storage and retrieval systems can be implemented for any materials (such as clean towers and media) that are transferred from one machine to the next. That notwithstanding, the mechanical and operational aspects of the present disclosure can be the same regardless of whether one machine or several are used.

Detailed Specification of the Machine

A detailed specification of the machine is given as follows. Towers are first loaded into the machine, for example via conveyance on rails. Then, during the media removal step, an automated pulling hook or machine arm (with one or more degrees of freedom) grabs the media strips within the tower and pulls or pushes them out of the tower. Once removed, the media is flattened out, either via an additional manipulator that pulls the media apart (either one end pulled and the other end fixed, or both ends pulled), or by pushing the folded media against a wedge or flat surface to open it up. As the media is flattened out, the growing plugs and plant root waste drop into a waste collection receptacle where they are stored or conveyed away.

Then, the media and towers are each cleaned. Cleaning can be accomplished with an array of nozzles placed on optionally rotating rods or bars. Cleaning nozzles in the nozzle array can also optionally be moved linearly along one or two axes. The rotation and linear motion of nozzles ensures that all surfaces are covered by the array. Spray ball or tank cleaning nozzles can be inserted into the interior of the towers and moved along their length in order to clean the tower insides. Multiple layers of nozzles (e.g. some facing upwards and some facing downwards) can also be implemented so that towers and media are cleaned on all sides. Regardless of the specifics of the nozzle array, media and towers can be first exposed to a sanitizing solution (high temperature water, steam, or a sanitizing solution such as dilute bleach), then to a rinsing solution (water), and finally to an optional spray of air for rapid drying. Nozzles can be spraying nozzles, i.e. for spraying and dispersing a fluid (water, air, or another fluid) into the air adjacent to the media or towers. More broadly, nozzles can be inlets for dispensing one fluid into another fluid, such as for filling up a cleaning tank that the towers or media are passed through.

Each of these solutions can be applied via one or more nozzle bars in sequence. It is helpful that the water jet solutions are dispensed at a high pressure, so that any root matter that has adhered onto the media strip can detach and be washed away. A holding cage can be placed around the entire tower and media cleaning area to prevent spraying water and air into the transplanting area or other areas. A manifold for drainage can be provided underneath the machine as well. Depending on the machine design, the media and towers can be cleaned either by a single set of nozzle bars or two sets (one for towers and one for media). While it is important that the media is slightly wetted before re-transplanting, the top surface of the tower can be made completely dry before re-transplanting, so that seedling canopies touching the surface of the tower do not get soaked.

After media removal and cleaning, the machine re-transplants the towers. This includes several steps. First, a tower and one or more new strips of media are prepared to be transplanted alongside an array of seedlings that are conveyed into the machine. Seedlings are housed within plug trays, either in individual plugs or in a hexagonal paper plug array, and conveyed into the machine for example on a conveyor belt. Seedlings can be true seedlings, i.e. plants started from seed, or alternatively they can be plant cuttings or other plant propagules suitable for growing in horticulture. Seedlings can be bare-rooted, or alternatively be housed within a small growing media plug such as a peat plug, coco plug, or other media plug.

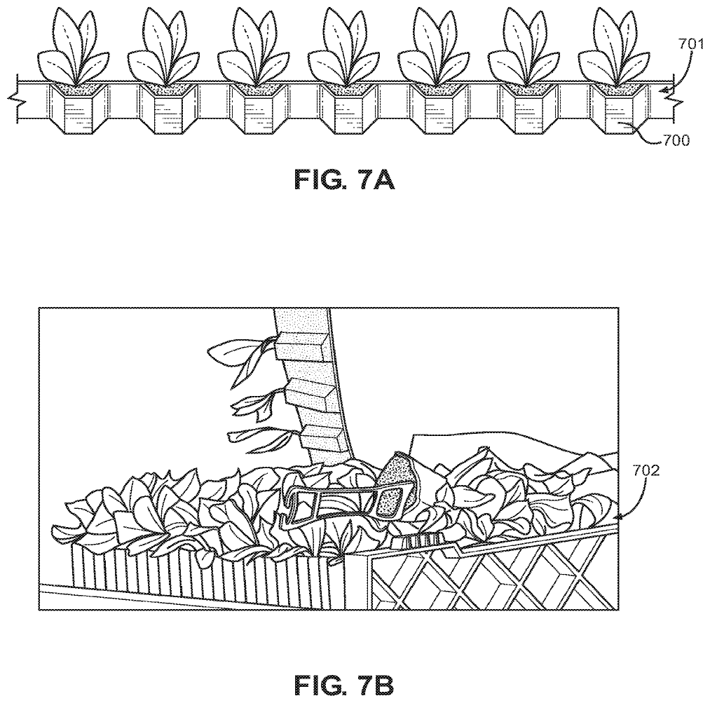

FIGS. 7A and 7B illustrate paper pot plugs in a chain and an array configuration, respectively. In a paper plug array, individual plugs 700 are bound within paper receptacles that cover all sides of the plug and optionally the bottom if the plug media is not stabilized with a binder. The lining of paper surrounding each plug is connected to that surrounding its two neighboring plugs, such that a continuous chain of paper 701 extends from plug to plug, as shown in FIG. 7A. During seedling production and transport, this chain of plugs can be arranged within a two-dimensional array 702, shown in FIG. 7B. Once the seedlings are ready for transplant, the paper chain ensures that each seedling gets pulled into the media strip by the one preceding it and at the right spacing, thus making it possible to transplant the seedlings using a simple pulling hook that grabs the first seedling in the chain instead of manipulating each seedling one by one. With a paper pot array, a separate wicking strip can be omitted, because the paper lining the chain in the paper pot array can double as the wicking strip.

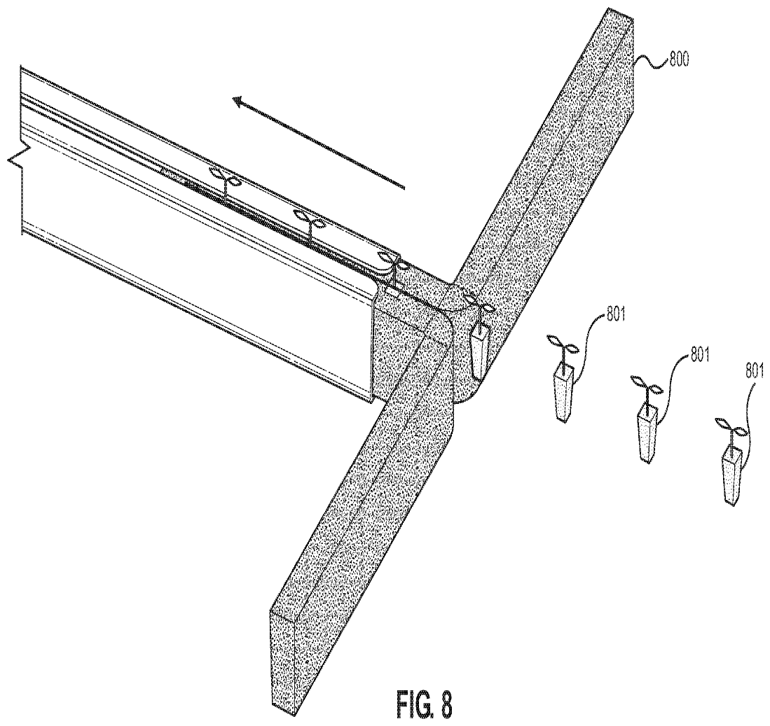

The machine can perform one of three general methods for transplanting. FIG. 8 illustrates a “zipping” method of transplanting. In the “zipping” method, the media 800 and the seedlings 801 are inserted into the tower simultaneously. The media 800 is conveyed into place so that it is perpendicular with the desired tower, guided for example by roller pins. A manipulator or pulling hook, situated for example on an overhead gantry, grabs the center of the media strip 800 and pulls it into the tower, while the outer ends of the media strip 800 are held in place and allowed to move against the roller pins. Optionally, prior to this, a wicking strip such as a strip of felt media can be extended along either the full length or half the length of the media strip 800, for example via an automated spool, so that when the media 800 is pulled into the tower the felt strip is pulled in with it. Simultaneously, a seedling 801 is placed within the jaws of the media strip 800 as it enters the tower, for example using a robotic plug manipulator.

After the manipulator places a single seedling 801 into the jaws of the media strip 800, the media strip 800 is pulled further into the tower and the process repeats. If a hexagonal paper pot array is used, there is no need for the robotic plug manipulator, because a paper strip connected to the first plug to go into the tower can be grabbed by the media pulling hook, causing the rest of the plugs to follow in a chain in the correct spacing automatically. A snipping mechanism, for example a robotic snipper, can be implemented to snip off the last plug to go into the tower from the rest of the paper pot array. Alternatively, the paper pot chain can be sized in segments matched to the media length. In the zipping mechanism, whether using a robotic plug manipulator or the paper pot method, the media 800 is pulled into the tower until it and the seedlings 801 are fully in the desired place. The zipping method can be performed with the towers and media oriented in any direction.

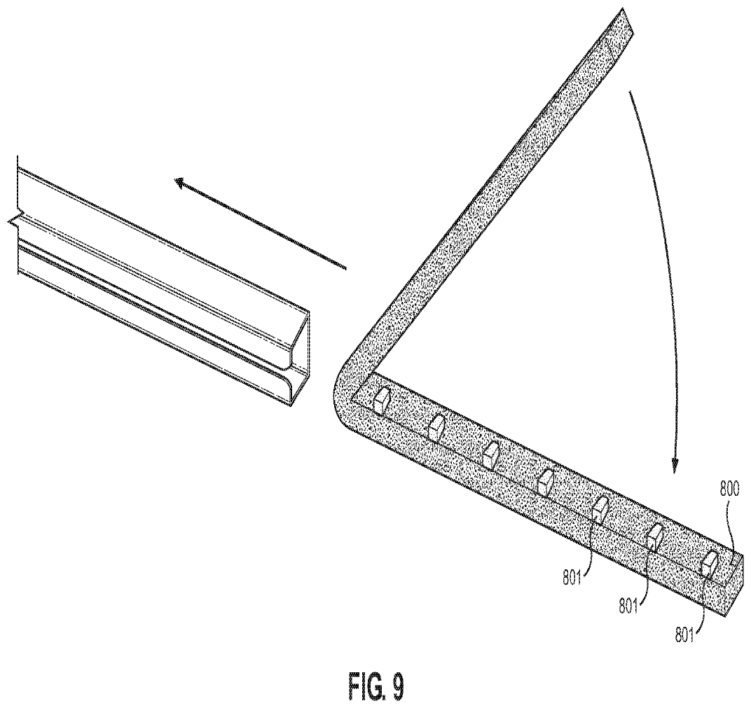

FIG. 9 illustrates a “sandwich” method of transplanting. In the “sandwich” method, the media strip 800 is folded in half completely, prior to insertion into the tower, with an array of seedlings 801 sandwiched within the two strips of media. The sandwiching can be performed either by a robotic manipulator gripping one or both ends of the media strip 800, or by an automated hinge mechanism. If the sandwich is made with the media strip 800 resting on its side, seedlings 801 can be put in place one by one, for example by a robotic manipulator, and left to rest on one side of the strip before the other side closes to create the sandwich. In other orientations, the seedlings 801 can be held all at once by a manipulator that can hold multiple seedlings 801 simultaneously, before the sandwich closes to hold them in place.

Once the sandwich is in place, it is optionally clamped together (which is not strictly needed if the sandwich is resting on its side) and then moved into the tower all at once, for example via a pulling hook. The wicking strip and paper pot method are options here too. While the sandwich method can be performed with the towers and media 800 oriented in any direction as long as the sandwich is clamped together, it can be helpful to perform this method with the media sandwich and tower resting on their sides. That way, the seedlings 801 remain in place, do not slip due to gravity, and do not require as much handling automation.

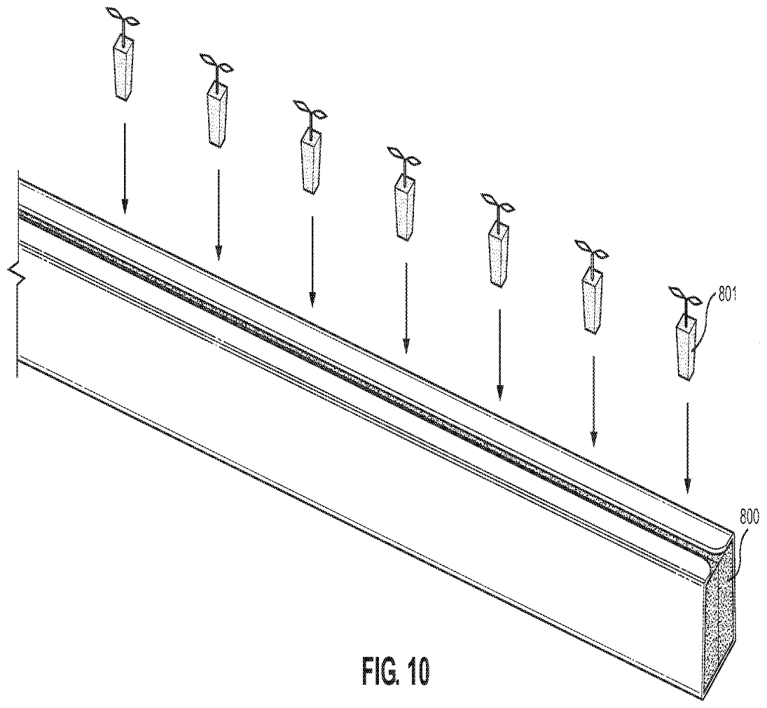

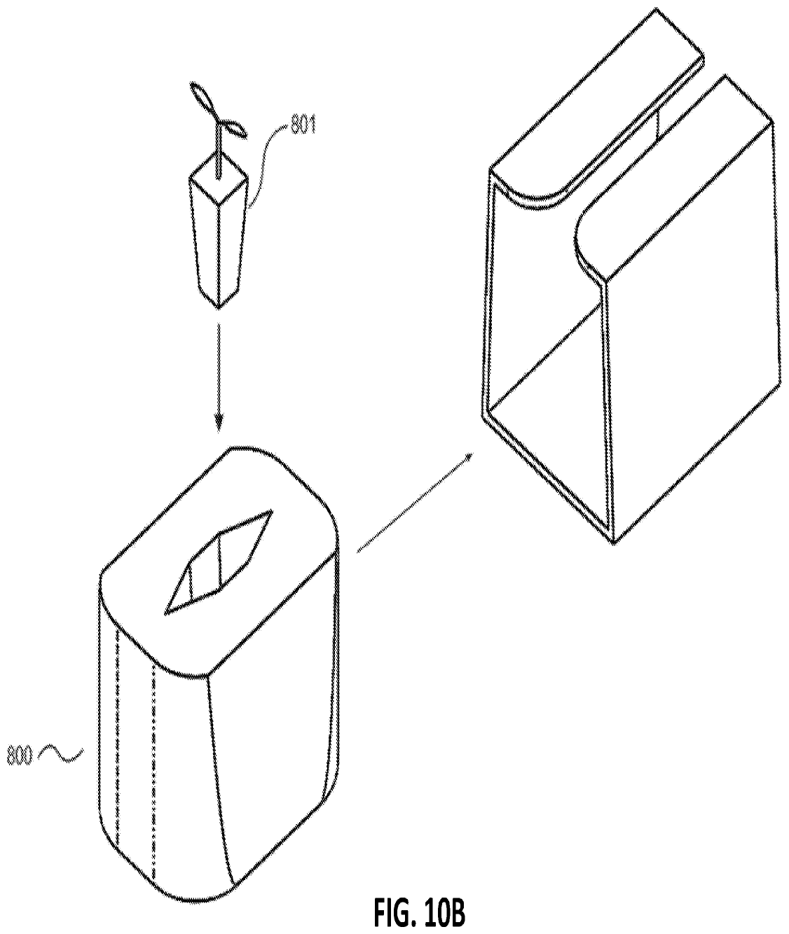

FIGS. 10A and 10B illustrate an “insertion” method of transplanting. In the “insertion” method shown in FIG. 10A, the media strip 800 with optional wicking strip is first loaded into the tower, for example via a pulling hook, and then once it is fully loaded the seedlings 801 are inserted into the groove in the tower via a robotic manipulator that forces the groove apart and forcefully inserts one or more seedlings 801. In the “insertion” method shown in FIG. 10B, the media material 800, instead of being folded, has one or more openings or slots for receiving at least one seedling, allowing a robotic manipulator to insert one or more seedlings 801 into the media material, either prior to or after the media material is inserted into the tower.

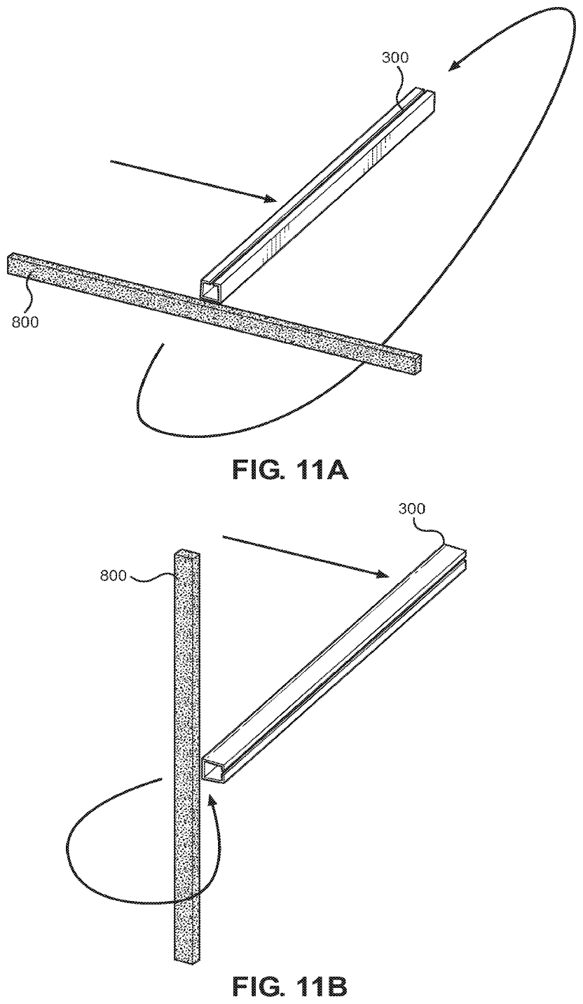

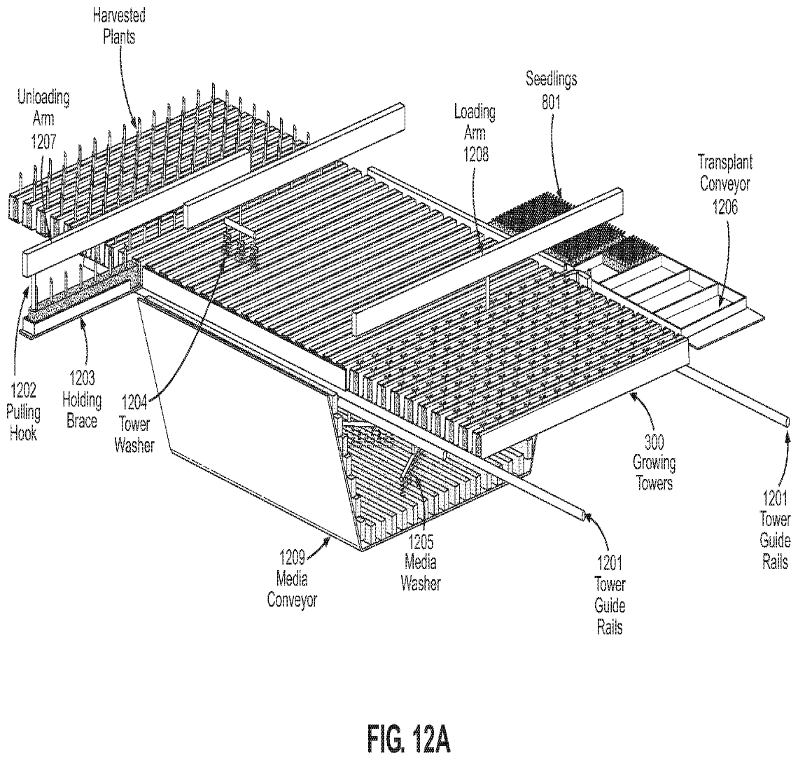

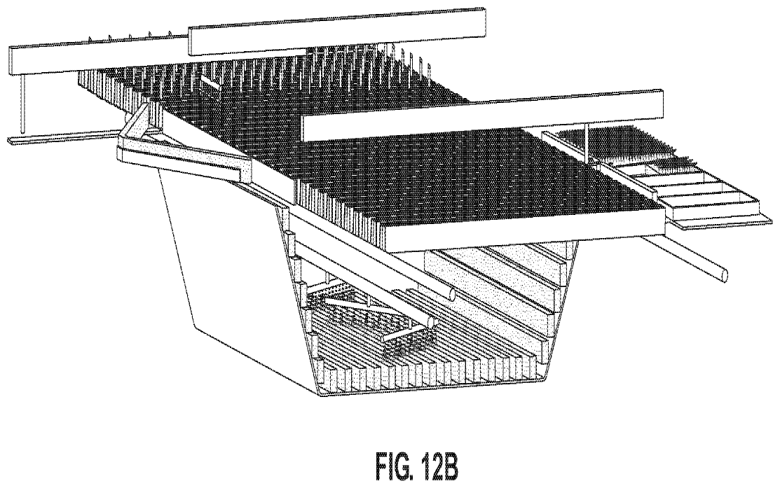

While numerous options are possible for how the towers and media are oriented at different steps as they flow into and through the machine, two examples of machine design architectures, shown in FIGS. 11A and 11B, are described with more details here.

FIG. 11A illustrates a first design, design A, in which towers 300 are conveyed into the machine with their fronts facing up. Media strips 800 are conveyed underneath or over the towers 300 to be re-transplanted on the other side, and the towers 300 are conveyed forwards in the direction of the straight arrow. Both the media 800 and the towers 300 are cleaned as they are indexed forwards. When re-transplanted, the zipper method is used.

In this first design, towers enter the machine in a direction perpendicular to their longitudinal axis, with their fronts facing up. The media strips are pulled out, plant waste is allowed to fall into a waste receptacle, and media strips are flattened and oriented to create a horizontal T-shape with the tower it is pulled from (shown in FIG. 11A). As the empty towers continue to move in the same direction as they entered, the media strips are conveyed underneath the towers so that they can be fed in to towers again on the opposite side. The conveyor underneath the towers holds the media strips in place, for example by using pins, or passive manipulators, normal to the conveyor's surface similar to pins in a dishwashing rack. Alternatively, the conveyor can be comprised of active manipulators (such as grabber arms) or passive manipulators (such as pins) that move along a track.

The media can be cleaned using nozzles while it is being conveyed underneath the towers, and the towers are cleaned using a separate set of nozzles above, while they are conveyed several tower widths forward. This distance allows an equal number of towers and media strips to be indexed forwards in their respective conveyance schemes. Once the media has passed all the way underneath the flow of towers to the other side, it is moved forwards in the direction the towers are moving (so that it is in alignment with the tower it goes into) and then re-transplanted into a clean tower. Media strips can be re-transplanted into the same (cleaned) towers they were pulled from, to prevent any queuing of towers or media and reduce the possibility of cross contamination from any residual pathogens or pests. Additional forwards indexing of both the towers and media (in the direction the towers are moving) can be implemented to further separate the cleaning and transplanting areas for sanitation and wetness reasons.

While any transplanting method can be used, in this machine shown in FIG. 11A, the towers 300 and media 800 are both facing up, which means that the zipping method, optionally using paper pots, can be readily implemented. In design A, since the media 800 re-enters the towers 300 on the opposite side it was pulled from, the towers 300 do not need to be re-oriented before re-entry into the machine at the end of their growth cycle. Thus, infeed and outfeed into the machine can be accomplished according to the material handling flow (e.g., shown in FIG. 4B).

FIG. 11B illustrates a second design, design B, in which towers 300 are conveyed into the machine with their fronts facing sideways. Media strips 800 and towers 300 are held in place while cleaned, and then optionally indexed forwards (in the direction of the straight arrow) to separate the cleaning and transplanting areas. When re-transplanted, the sandwich method is used, during which the towers 300 and media sandwiches 800 are both resting on their sides.

In this second design, towers enter the machine in a direction perpendicular to their longitudinal axis, with their fronts facing sideways. The media strips are pulled out, plant waste is allowed to fall into a receptacle, and then the strips are flattened and oriented to create a sideways T-shape with the tower it is pulled from. Then, the media strip and tower are both cleaned while being held in place—no indexing forward is needed in this design since the media strip does not have to travel any distance before being re-transplanted. Forwards indexing can be used, however, to separate the cleaning and transplanting areas. In this case, media strips are indexed forwards in the vertical position and move sideways in the same direction as the towers, for example via a set of arms or a vertical plane conveyor rack with pins. Once the media and tower both have been cleaned, the media is transplanted back into the same tower it was pulled from, for example using the same manipulator that was used to remove the media from the tower.

While any transplanting method can be used, in this machine design the towers are facing sideways and so the sandwich method can be readily implemented. During sandwiching, the media strips are brought back to rest in the horizontal plane, creating sandwiches resting on their sides. In design B, since the media re-enters the towers on the same side it was pulled from, the towers can be re-oriented before re-entry into the machine at the end of their growth cycle. Thus, infeed and outfeed into the machine can be accomplished according to the material handling flow shown in FIG. 4B.

Both designs A and B, shown in FIGS. 11A and 11B, respectively, can be implemented with a wide variety of options and details chosen from the specifications above.

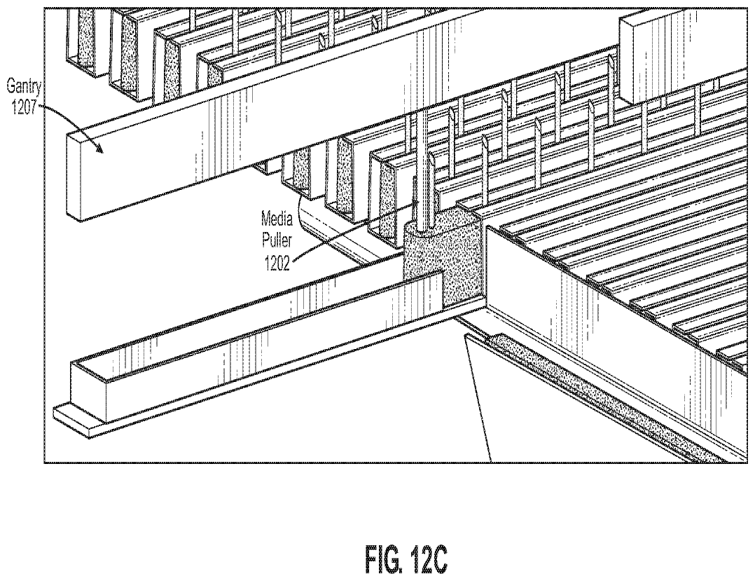

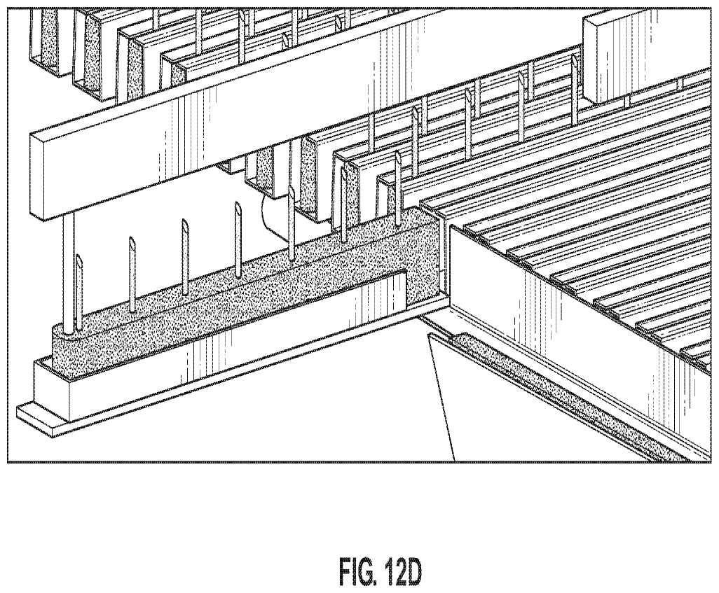

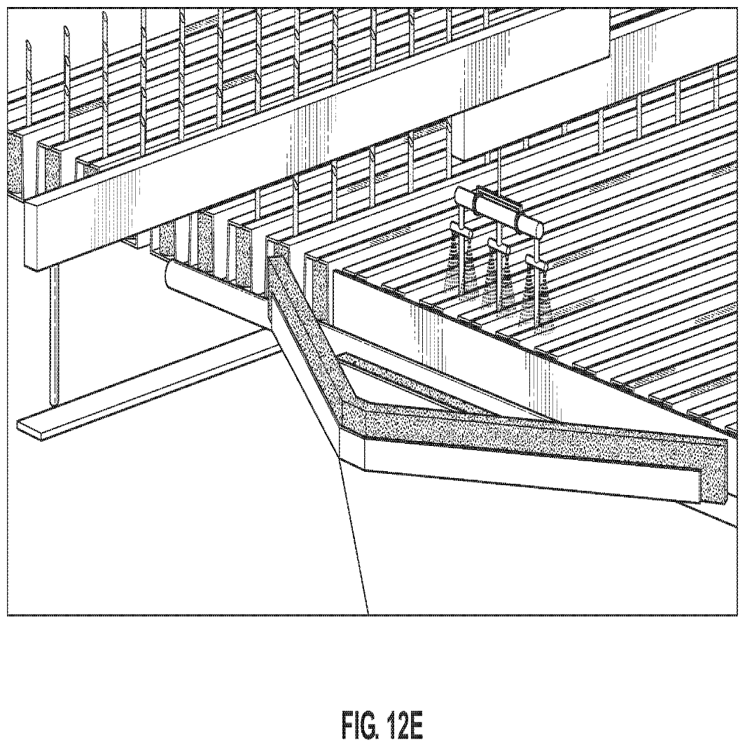

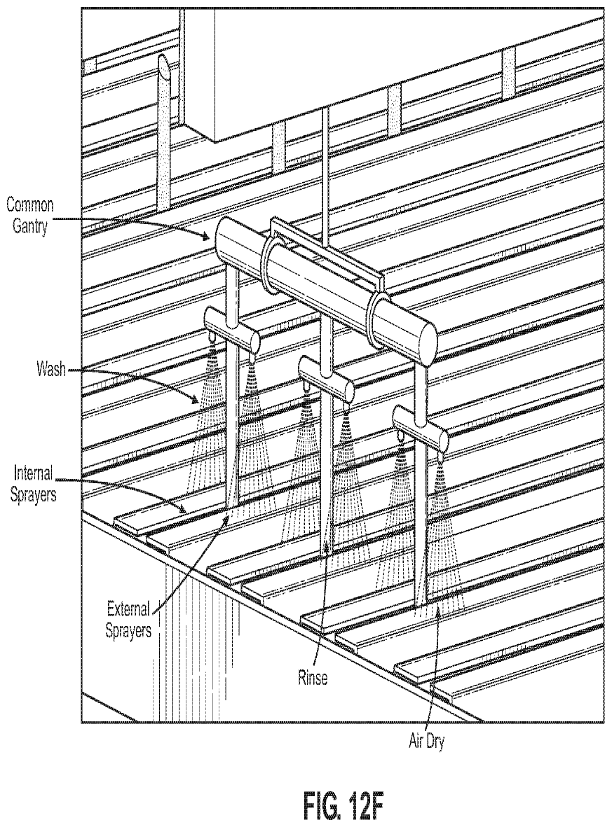

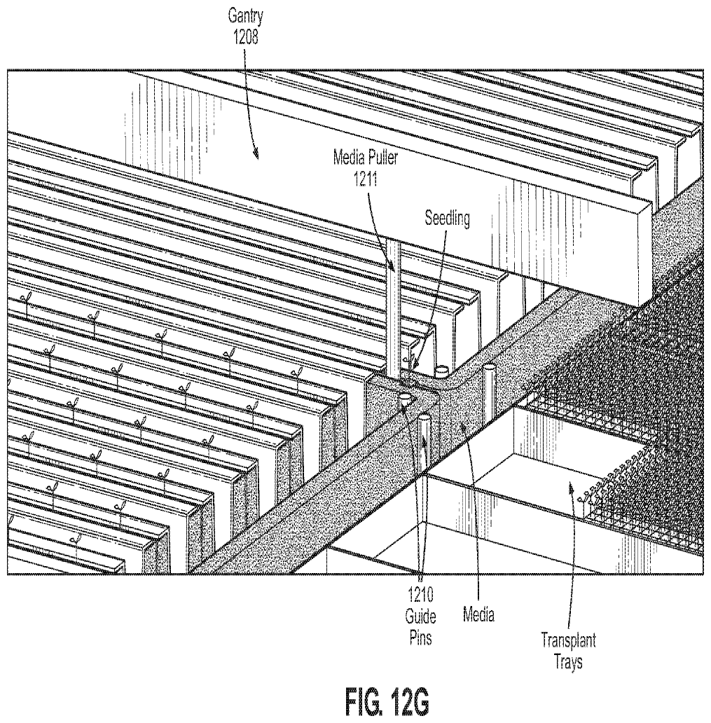

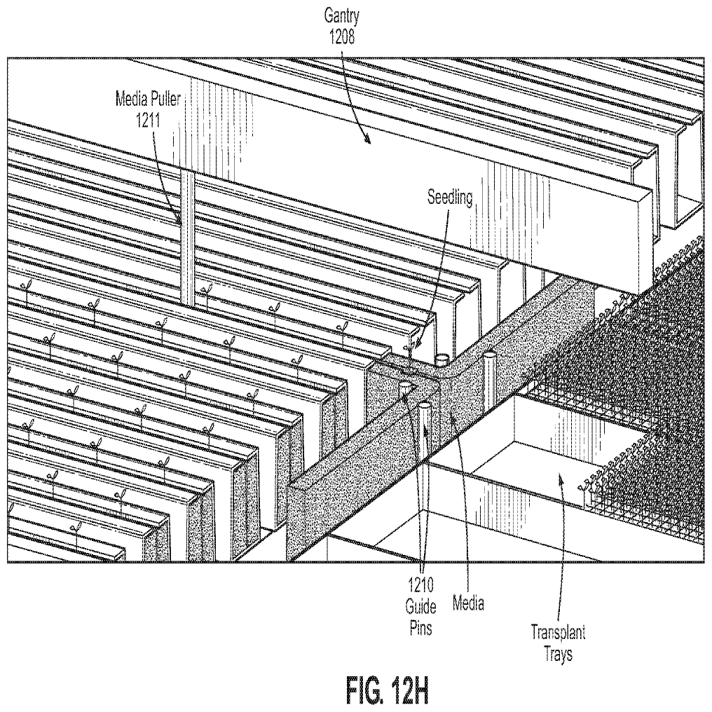

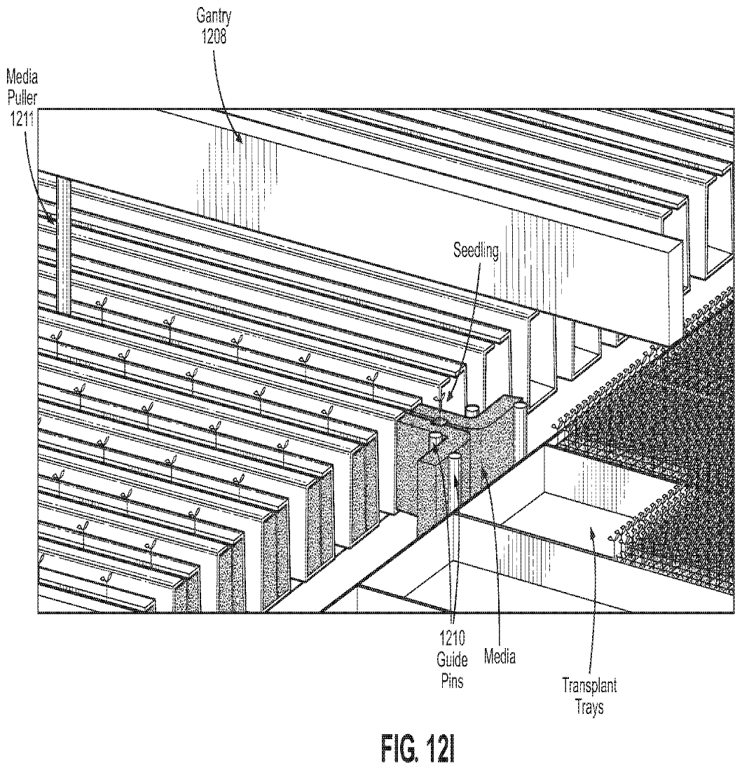

FIGS. 12A-12I illustrate detailed drawings of the machine design shown in FIG. 11A Angled slot openings and hanging holes on each tower are not shown. More specifically, FIG. 12A shows a top view of the machine. FIG. 12B illustrates washing of media below the towers. FIG. 12C illustrates the initial removal of media. FIG. 12D illustrates the full removal of media. FIG. 12E illustrates the unfolding of media. FIG. 12F illustrates the washing of towers (a similar mechanism exists for washing media below). FIG. 12G illustrates the initial entry of media into tower during transplanting via the zipper method. FIG. 12H illustrates intermediate entry of media into tower during transplanting via the zipper method. FIG. 12I illustrates close to final position of media in tower during transplanting via the zipper method. Although FIGS. 12A-12I illustrate certain details for design A, it is understood that one skilled in the art can infer a similar level of detail for other implementations of design A and also for design B and other possible designs within the specifications above.

In the machine shown in FIGS. 12A-12I, towers 300 enter the machine held in place by guide rails 1201 (see FIGS. 12A and 12B). Seedlings 801 are brought into the transplanting area along a belt conveyor 1206. The media strips are pulled with an overhead pulling hook 1202 of an unloading arm 1207 into a hinged holding brace 1203 (see FIGS. 12C and 12D). The hinged holding brace 1203 then opens and flattens the media strips against a flattening wall (see FIG. 12E).

Above the towers, there are three sets of tower washer nozzles 1204, for washing, rinsing, and air drying respectively, each arranged in sets (see FIG. 12F). Each set of nozzles has three nozzles: one center nozzle and two side nozzles. The outer nozzles are for washing the top surfaces of the tower, whereas the middle nozzle is a tank cleaning or spray ball nozzle for cleaning the inside of the tower. The entire set of nozzles moves linearly along the length of three towers, forwards in a “pass” and backwards in a “return”. In between each pass and return, the towers 300 are indexed one tower forwards, such that the tower previously being washed is now being rinsed, and the tower previously being rinsed is now being dried. In between indexing, the center nozzles have to lift upwards and be reinserted into the next tower. Another layer of nozzles (not shown) can be placed below the tower guide rails pointing upwards, to clean the undersides of the towers 300.

For cleaning the media, a separate set of nozzles 1205 (which can rotate but don't need to translate) is placed in the undercarriage of the machine below the towers 300 (see FIG. 12B). As media strips move along media conveyor 1209, they first can be exposed to a line (or rotating line) of washing nozzles 1205 (shown in FIG. 12B), then to a line or rotating line of rinsing nozzles (not shown), and an optional line or rotating line of drying nozzles (not shown). Another layer of nozzles (not shown) can be placed below the undercarriage facing upwards to clean the bottoms of the media strips. However, this is less necessary for media than for towers because the media strips, if they are porous, can more easily be cleaned from three sides alone than the towers.

A holding cage (not shown) can be placed around the cleaning area to prevent water and air sprays from coming into the transplanting area or other undesired areas. A manifold for drainage (not shown) can be provided underneath the machine as well. Finally, on the re-transplanting side, the zipper method of transplanting is accomplished using an overhead pulling hook 1211 on a gantry 1208 and a set of rolling guide pins 1210 for aligning the media into the towers (FIGS. 12G-12I).

In both designs, while each step is being performed on one tower or media strip, other steps can be performed simultaneously on other towers and media strips, in order for the machine to properly index forwards. The timing and coordination of these steps can vary slightly from one embodiment of the machine to the next.

For machine design A shown in FIG. 11A, an example timeline of steps is shown below. In this example, each tower contains 2 media strips, and the timeline lays out simultaneous actions taken by the machine at the media removal, tower cleaning, and transplanting steps, as well as the movement of tower and media conveyors. In the timeline below, the tower at the media removal step has media strips A and B, while the tower at the transplanting step has media strips X and Y.

Timeline:

Step 1: Remove media A, Insert media X, and Begin tower cleaning pass;

Step 2: Move media Y to loading position, Open media A, and Continue tower cleaning pass;

Step 3: Index media conveyor forwards, and Finish tower cleaning pass;

Step 4: Remove media B, Insert media Y, and Begin tower cleaning return;

Step 5: Move media Z to loading position, Open media B, and Continue tower cleaning return;

Step 6: Index media conveyor forwards, and Finish tower cleaning return;

Step 7: Index towers forwards.

Again, while the specification here has described a single integrated machine performing all steps from media removal to re-transplanting, it is entirely within the scope of the present disclosure to separate each of these steps into multiple separate machines, either co-located or located in separate areas. For example, at least one of (a) the cleaning nozzles, (b) the loading arm, and (c) the unloading arm may be physically decoupled from the other parts of the machine. In some embodiments components may perform multiple functions. For example, in some embodiments the loading arm may also be the unloading arm. Moreover, there may be multiple of each component. For example, there may be a plurality of loading arms and a plurality of unloading arms. If separate machines are used, storage and retrieval systems can be implemented for any materials (such as clean towers and media) that need to be transferred from one machine to the next. That notwithstanding, the mechanical and operational aspects of the present disclosure are the same regardless of whether one machine or several are used.

One final machine architecture worth describing is one which can be used on multiple shorter towers. If towers are short in length, for example between 0.1 times and 10 times their width, then they can move through the machine parallel to their longitudinal axis. Short towers require more handling operations per length of tower. Thus, a machine architecture that can be used on shorter towers is one in which there are multiple towers being acted upon by the machine at once. There can be an array of multiple manipulators both for removing media and reinserting media into the towers. In one example, the media material, instead of being folded in half or otherwise forming a U-shape e.g. by having two strips connected via a bolt, can simply be a single strip with one or more openings, holes, or slots for accepting seedlings. In another example, the manipulator for removing the media material from the tower can push the media material out of the tower, instead of pulling it. This is particularly useful if the towers are short in length. The manipulator in this case must simply have enough contact with the media material required to push the media material out of the tower. Thus, in general, the media removal and insertion manipulators must simply be able to have enough contact with the media material to push or pull it out of or into the tower.

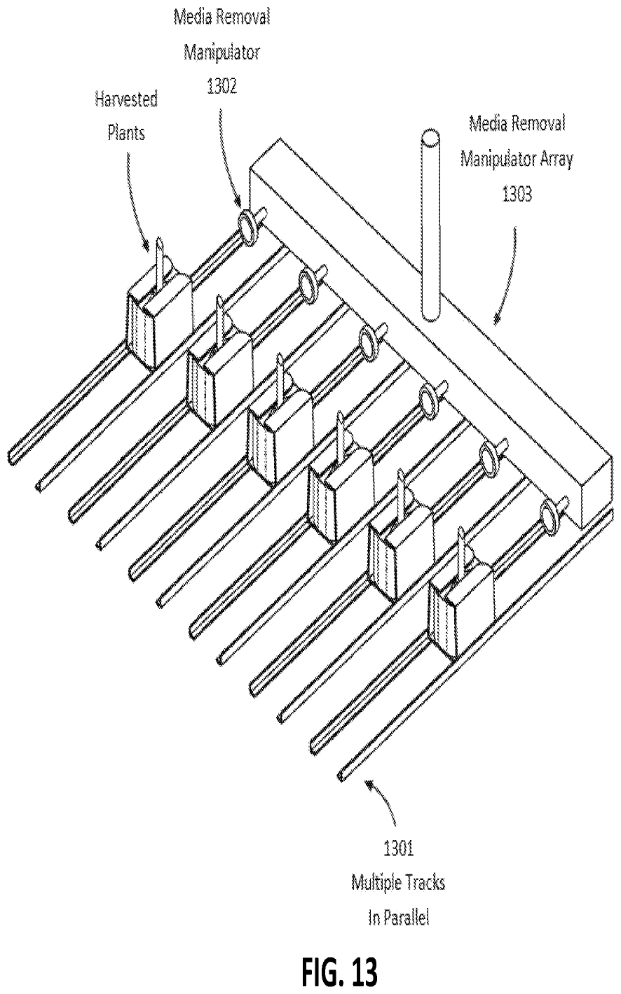

In this machine architecture, the towers can move through the machine along multiple tracks. An example of this machine architecture is shown in FIG. 13, corresponding to the flow of towers through a machine shown in FIG. 3D. As shown in FIG. 13, there can be multiple tracks 1301 arranged parallel to each other for at least a portion of the tracks. The machine can have a media removal manipulator array 1303, comprising at least one media removal manipulator 1302. Each media removal manipulator 1302 can remove the media material from at least one tower by making contact with the media material and pushing or pulling it out of the tower. The media removal manipulator array can move along a gantry, not shown. Also not shown, there can be a media insertion manipulator array comprising at least one media insertion manipulator, similar in fashion to the media removal manipulator array and media removal manipulator.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present.

The above-described embodiments can be implemented in any of numerous ways. For example, embodiments of designing and making the technology disclosed herein may be implemented using hardware, software or a combination thereof. When implemented m software, the software code can be executed on any suitable processor or collection of processors, whether provided in a single computer or distributed among multiple computers.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of” “only one of” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

A method for handling, cleaning, and transplanting growing towers, as shown and described.

A method substantially as herein described.

An apparatus substantially as herein described.

An apparatus for handling, cleaning, and transplanting growing towers, as shown and described.

What is claimed:

1. An apparatus for growing plants, the apparatus comprising:
a plurality of towers, each tower comprising:
a front side, a back side, an open first end, and an open second end;
at least one slot or hole formed in the front side of the tower;
a media material removably inserted into the tower;
a longitudinal axis intersecting the first and the second end of the tower;
at least one track for supporting and circulating the plurality of towers into and through a machine, such that each tower moves in a direction at least partially parallel to its own longitudinal axis, during at least part of its residence in the machine;
the machine having a first plurality of manipulators, each for making contact with at least one media material and removing it out of the first end or second end of least one tower;
the machine having one or more cleaning nozzles for cleaning at least one media material and at least one tower;
the machine having a second plurality of manipulators, each for making contact with a clean media material and inserting it into the first end or second end of at least one tower;

2. The apparatus of claim 1, wherein each tower of the plurality of towers has a length from its first end to its second end between 0.1 times and 10 times the width of the tower.

3. The apparatus of claim 1, wherein the at least one track comprises multiple tracks arranged parallel to each other for at least a portion of the tracks.

4. An apparatus for growing plants, the apparatus comprising:
a tower having a front side, a back side, an open first end, and an open second end;
at least one slot or hole formed in the front side of the tower;
a media material removably inserted into the tower;
a track for supporting and circulating a plurality of towers into and through a machine;
the machine having a first manipulator for making contact with the media material and removing it out of either the first end or the second end of the tower;
the machine having one or more cleaning nozzles for cleaning the media material and the tower;
the machine having a second manipulator for making contact with a clean media material and inserting it into either the first end or the second end of the tower.

5. The apparatus of claim 4, wherein at least one of (a) the cleaning nozzles, (b) the first manipulator, or (c) the second manipulator is physically decoupled from the other parts of the machine.

6. The apparatus of claim 4, wherein the track reorients the plurality of towers from a vertical orientation to a horizontal orientation prior to entry into the machine.

7. The apparatus of claim 4, wherein the track reorients the plurality of towers from a horizontal orientation to a vertical orientation after exit from the machine.

8. The apparatus of claim 4, wherein the track reorients the plurality of towers from a vertical orientation with the first end of the towers facing upwards prior to entry into the machine, to a vertical orientation with the second of the towers end facing upwards after exit from the machine.

9. The apparatus of claim 4, wherein the track reorients the plurality of towers from a vertical orientation with the second end of the towers facing upwards prior to entry into the machine, to a vertical orientation with the first end of the towers end facing upwards after exit from the machine.

10. The apparatus of claim 4, wherein the track comprises a first rail and a second rail.

11. The apparatus of claim 4, wherein the first manipulator is the second manipulator, or the first manipulator is different from the second manipulator.

12. The apparatus of claim 4, wherein at least one of the first manipulator and the second manipulator are pulling hooks.

13. The apparatus of claim 4, wherein at least one of the first manipulator and the second manipulator are grabbing arms with one or more degrees of freedom.

14. The apparatus of claim 4, further comprising a first set of cleaning nozzles for cleaning the media material and a different second set of cleaning nozzles for cleaning the tower.

15. The apparatus of claim 4, wherein each of the one or more cleaning nozzles are configured to sanitize, rinse, or dry.

16. The apparatus of claim 4, further comprising a conveyor for moving one or more seedlings into a transplanting area.

17. The apparatus of claim 4, wherein the media material has a thickness substantially half an internal width of the tower, and wherein the media material, when inside the tower, is folded in the middle so that the thickness of both halves together approximately equals the inside dimensions of the tower.

18. The apparatus of claim 4, wherein the media material is composed of two halves of material split down the middle with a bolt spanning a width of the two halves for joining the two halves.

19. The apparatus of claim 15, wherein the second manipulator zips the media material into the tower by pulling the center of the media material into the tower;
and further comprising at least a third manipulator for placing one or more seedlings within the two halves of the media material as it zips into the tower.

20. The apparatus of claim 15, further comprising at least a third manipulator for placing one or more seedlings within the two halves of the media material and pressing the two halves together into a sandwich before the sandwiched media material is pulled into the tower.

21. The apparatus of claim 4, further comprising at least a third manipulator for inserting one or more seedlings into the media material through the front side of the tower, after the media material has been inserted into the tower.

22. A method for growing plants, the method comprising:
providing a tower having a front side, a back side, an open first end, and an open second end;
providing at least one slot or hole formed in the front side of the tower;
providing a media material inserted into the tower;
circulating a plurality of towers on at least one track into and through a machine;
the machine manipulating the media material and removing it out of the tower;
the machine cleaning the media material and the tower with one or more cleaning nozzles;
the machine manipulating a clean media material and inserting it into the tower.

23. The method of claim 22, further comprising:
reorienting the tower from a vertical orientation to a horizontal orientation prior to entry into the machine.

24. The method of claim 22, further comprising:
reorienting the tower from a horizontal orientation to a vertical orientation after exit from the machine.

25. The method of claim 22, wherein the at least one track comprises a first rail and a second rail.

26. The method of claim 22, wherein the at least one track comprises multiple tracks arranged in parallel to each other for at least a portion of the tracks.

27. The method of claim 22, further comprising:
moving the media material under or over the tower.

28. The method of claim 22, wherein the machine comprises a first manipulator for grabbing the media material and pulling it out of the tower and a second manipulator for grabbing the clean media material and inserting it into the tower.

29. The method of claim 22, wherein the machine comprises a first pulling hook for grabbing the media material and pulling it out of the tower and a second pulling hook for grabbing the clean media material and inserting it into the tower.

30. The method of claim 22, wherein the machine comprises a first set of cleaning nozzles for cleaning the media material and a different second set of cleaning nozzles for cleaning the tower.
